(19) United States
(12) Patent Application Publication
(10) Pub. No.: US 2018/0163943 A1
(43) Pub. Date: Jun. 14, 2018

(54) WIDE-ANGLE ILLUMINATION AND WATERPROOF LED LAMP STRUCTURE

(71) Applicant: Xiamen PVTECH Co., Ltd., Xiamen (CN)

(72) Inventors: FUXING LU, Xiamen (CN); RUICHA LAI, Xiamen (CN)

(21) Appl. No.: 15/721,953

(22) Filed: Oct. 1, 2017

(30) Foreign Application Priority Data
Dec. 9, 2016 (CN) 201611129557.0

(51) Int. Cl. F21S 8/10

(52) U.S. Cl. CPC F21S 48/33; F21S 48/2212; F21S 48/234; F21S 48/215

(57) ABSTRACT

A wide-angle illumination and waterproof LED lamp structure is provided. A wide-angle illumination and waterproof LED lamp structure comprises: a tubular body, a power module, a first waterproof lamp cap, a second waterproof lamp cap, and a LED module. The wide-angle illumination and waterproof LED lamp structure in the embodiments of the invention has a good waterproof function, and thus it is adapted to be applied in an environment with a requirement of waterproof function.

### BACKGROUND OF THE INVENTION

### 1. Field of the Invention

The invention relates to a wide-angle illumination and waterproof Light Emitting Diode (LED) lamp structure and, more particularly, relates to a LED illuminating lamp with high a waterproof function and a wide-angle light source.

### 2. Description of the Prior Art

Lamps with a fluorescent tube which provides white light illumination as a lighting source are widely used in the indoor lighting field for years. Due to the advantages of simple and easy to be assembled, the lamps of this type are wildly used.

However, the fluorescent tube is large. Moreover, heavy mercury pollution is generated in manufacture, use and disposal processes, which is a potential heavy metal pollution source in the environmental protection. The service life of the fluorescent tube is very short, only about 1000 hours. Only ten percent of the received electric energy can be converted into light energy while ninety percent is converted into useless heat energy to be dissipated into the air. Obviously, the electric energy is wasteful, and the burden on the natural environment is heavy.

In recent years, the LED lighting technology is developed and widely used in daily life, for example, the field of information technology, communication technology, consumer electronics, and display devices. With the launch of the white light LED, the LED is further developed as a new and potential light source. More acceptable products for consumers are also developed.

LED has a lot of advantages, such as environmental protection, electricity saving, high efficiency and long service life, small in size, fast in reaction and the like. As a result, to overcome the defects of the fluorescent tube and meet the requirements on the environmental protection, energy conservation and emission reduction, LED tubes are developed to replace conventional fluorescent tubes. LED lamps are gradually used in various lighting fields. The Led lighting technology is regarded as a welcome light source in the 21 century. The Led lighting technology may replace conventional light sources and becomes to a mainstream illumination light source.

However, a tube-shaped LED lamp (such as a T5 model) does not have a waterproof structure. Therefore, the lamp is easily damaged when used in an environment with a waterproof requirement.

The outer lamp cover of a tube-shaped LED lamp tube (such as a T5 model) is usually a semi-circular shell, and thus the light emitting surface of is small. Consequently, the emitted light is too concentrated and not uniform.

### SUMMARY OF THE INVENTION

A wide-angle illumination and waterproof LED lamp structure is provided. A wide-angle illumination and waterproof LED lamp structure comprises: a tubular body, wherein the tubular body is tubular shaped and hollow, two ends of the tubular body defines openings, respectively, the tubular body includes a chamber portion and a lamp cover, a cross section of the chamber portion is rectangle, the lamp cover is permeable to light, and the chamber portion is communicated with the lamp cover; the power module secured in the chamber portion of the tubular body; the first waterproof lamp cap is sealingly secured to one of the openings of the tubular body, a shape of the cross section of the first waterproof lamp cap is corresponding to the cross section of the opening, a sealing structure is formed at a wedge surface of the first waterproof lamp cap; a second waterproof lamp cap is sealingly secured to the other one of the openings of the tubular body, the shape of the cross section of the second waterproof lamp cap is corresponding to the cross section of the opening, and a sealing structure extends from a wedge surface of the second waterproof lamp cap; and a LED module secured in the lamp cover and electronically connected to the power module.

In an embodiment, at least two first fastening units are formed at inner surfaces of the tubular body adjacent to the opening, at least two second fastening units are formed at a side of the first waterproof lamp cap and the second waterproof lamp cap. Said first fastening unit corresponds to the second fastening unit, and the first fastening unit is able to engage with the second fastening unit.

In an embodiment, the first fastening unit is a hole or a recess, and the second fastening unit is a protrusion.

In an embodiment, the angular range of the lamp cover is more than 240 degrees.

In an embodiment, a plurality of through holes are formed on the second waterproof lamp cap, the through holes pass through the sealing structure and communicate with an inner space of the tubular body, so as to facilitate electrical wire configuration.

The wide-angle illumination and waterproof LED lamp structure in the embodiments of the invention has a good waterproof function, and thus it is adapted to be applied in an environment with a requirement on the waterproof.

### BRIEF DESCRIPTION OF THE DRAWINGS

These and other features, aspects and advantages of the invention will become better understood with regard to the following embodiments and accompanying drawings.

FIG. 1 is an exploded view of a wide-angle illumination and waterproof LED lamp structure in an embodiment; and

FIG. 2 is a perspective view showing an exterior of a wide-angle illumination and waterproof LED lamp structure in an embodiment.

### DETAILED DESCRIPTION

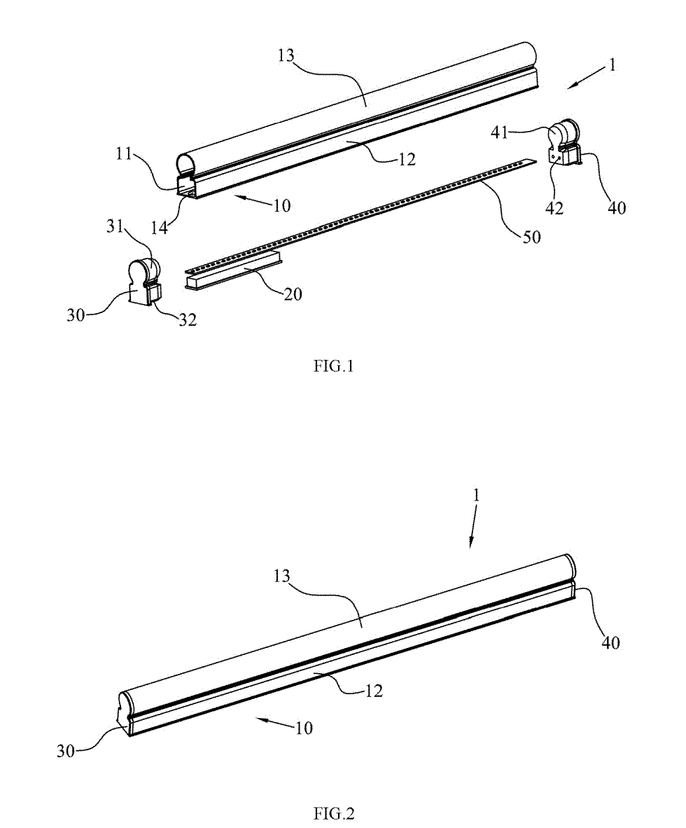

FIG. 1 is an exploded view of a wide-angle illumination and waterproof LED lamp structure in an embodiment. FIG. 2 is a schematic diagram showing an exterior of a wide-angle illumination and waterproof LED lamp structure in an embodiment. As shown in FIG. 1 and FIG. 2, in an embodiment, a wide-angle illumination and waterproof LED lamp structure 1 includes a tubular body 10, a power module 20, a first waterproof lamp cap 30, a second waterproof lamp cap 40, and a LED module 50.

In an embodiment, the tubular body 10 is a tubular shaped and hollow tube. Two ends of the tubular body define openings 11, respectively. The tubular body 10 includes a chamber portion 12 and a lamp cover 13. The cross section of the chamber portion 12 is rectangle. The lamp cover 13 is permeable to light. The angular range of the lamp cover 13 is more than 240 degrees. The chamber portion 12 is communicated with the lamp cover 13. A first fastening unit 14 is formed at an inner surface of the tubular body close to each of the openings 11, respectively. The first fastening unit 14 is a hole or a recess, which is not limited herein.

The power module 20 is secured in the chamber portion 12 of the tubular body 10 to provide power for the illumination via wires.

The first waterproof lamp cap 30 is sealingly secured to one of the openings 11 of the tubular body 10. The shape of the cross section of the first waterproof lamp cap 30 is corresponding to that of the opening 11. A second fastening unit 32 is formed in a side of the first waterproof lamp cap 30. The second fastening unit 32 is configured to be engaged with the first fastening unit 14. In an embodiment, the second fastening unit 32 is a protrusion. When the first waterproof lamp cap 30 mounted into the opening 11, with the force when the first fastening unit 14 engages with the second fastening unit 32, the first waterproof lamp cap 30 is secured to the opening 11. A sealing structure 31 extends from a wedge surface of the first waterproof lamp cap 30. The sealing structure 31 plugs and seals the opening 11 to achieve a waterproof function.

The second waterproof lamp cap 40 is sealingly secured to the other opening 11 of the tubular body 10. The shape of the cross section of the second waterproof lamp cap 40 corresponds to that of the opening 11. A second fastening unit 32 is formed at a side of the second waterproof lamp cap 40. The second fastening unit 32 is configured to engaging with the corresponding first fastening unit 14 when they contact. In an embodiment, the second fastening unit 32 is a protrusion. When the first waterproof lamp cap 40 mounted into the opening 11, with the force when the first fastening unit 14 engages with the second fastening unit 32, the second waterproof lamp cap 40 is secured to the opening 11.

A sealing structure 41 extends from a wedge surface of the second waterproof lamp cap 40. The sealing structure 41 plugs and seals the opening 11 to achieve a waterproof function. Moreover, in an embodiment, the second waterproof lamp cap 40 further includes a plurality of through holes 42. The through holes 42 are passing through the sealing structure 41 and communicating with inner space of the tubular body 10 to facilitate the electrical wire configuration of the power module 20.

The LED module 50 is secured in the lamp cover 13 and electronically connected to the power module 20.

The wide-angle illumination and waterproof LED lamp structure in the embodiments of the invention has a good waterproof function, and thus it is adapted to be applied in an environment with a requirement on the waterproof. Furthermore, in an embodiment, the cross section of the lamp cover is a sector which is more than ⅔ of a whole circle. Consequently, the illumination of the light source has wide-angle and is uniform.

Although the invention has been disclosed with reference to certain embodiments thereof, the disclosure is not for limiting the scope. Persons having ordinary skill in the art may make various modifications and changes without departing from the scope of the invention. Therefore, the scope of the appended claims should not be limited to the description of the embodiments described above.

What is claimed is:

1. A wide-angle illumination and waterproof Light Emitting Diode (LED) lamp structure, comprising:
a tubular body being tubular shaped and hollow, two ends of the tubular body defining openings, respectively, the tubular body including a chamber portion having a rectangular cross section; and
a lamp cover being permeable to light and being communicated with the chamber portion;
the power module secured in the chamber portion of the tubular body;
a first waterproof lamp cap being sealingly secured to one of the openings of the tubular body, a shape of the cross section of the first waterproof lamp cap being corresponding to the cross section of the opening, a sealing structure extending from a wedge surface of the first waterproof lamp cap;
a second waterproof lamp cap being sealingly secured to the other one of the openings of the tubular body, the shape of the cross section of the second waterproof lamp cap is corresponding to the cross section of the other opening, and a sealing structure extending from a wedge surface of the second waterproof lamp cap; and
a LED module secured in the lamp cover and electronically connected to the power module.

2. The wide-angle illumination and waterproof LED lamp structure according to claim 1, wherein at least two first fastening units are formed at an inner surface of two ends of the tubular body adjacent to each of the openings, respectively, at least two second fastening units are formed at a side of the first waterproof lamp cap and a side of the second waterproof lamp cap, respectively, each of the first fastening unit being corresponding to each of the second fastening unit, and the second fastening unit is configured to engaging with the corresponding first fastening unit.

3. The wide-angle illumination and waterproof LED lamp structure according to claim 2, wherein the first fastening unit is a hole or a recess, and the second fastening unit is a protrusion.

4. The wide-angle illumination and waterproof LED lamp structure according to claim 1, wherein the angular range of the lamp cover is more than 240 degrees.

5. The wide-angle illumination and waterproof LED lamp structure according to claim 1, wherein a plurality of through holes are formed on the second waterproof lamp cap, the through holes pass through the sealing structure and communicate with an inner space of the tubular body.
